(19) United States
(12) Patent Application Publication
(10) Pub. No.: US 2010/0309099 A1
(43) Pub. Date: Dec. 9, 2010

(54) Display device and driving method thereof

(76) Inventor: Woung Kim, Yongin-City (KR)

Correspondence Address: LEE & MORSE, P.C., 3141 FAIRVIEW PARK DRIVE, SUITE 500, FALLS CHURCH, VA, 22042, US

(21) Appl. No.: 12/591,589

(22) Filed: Nov. 24, 2009

(30) Foreign Application Priority Data
Jun. 5, 2009 (KR) 10-2009-0050025

(51) Int. Cl. G09G 3/20; H04N 9/64

(52) U.S. Cl. 345/55; 348/708

(57) ABSTRACT

A display device includes an image processing unit and a display unit. The image processing unit applies image processing algorithms to an input video signal to generate a corrected input video signal and includes an input for a regional information signal, the regional information signal including information regarding coordinates representing location and boundaries of at least one active region in the display unit per frame and resolution of the at least one active region. The display unit displays images in accordance with the corrected input video signal.

### BACKGROUND

1. Field

Example embodiments relate to a display device and a driving method thereof, and more particularly, to an organic light emitting diode (OLED) display and a method of driving the same.

2. Description of the Related Art

A display device includes a plurality of pixels arranged on a substrate, e.g., in a form of a matrix, which define a display area of the display device. The display device also includes scan and data lines connected to respective pixels. Data signals are selectively applied to the pixels to display desired images in the display area of the display device. The display devices may be classified into passive and active matrix types, depending upon a method of driving the pixels. In view of resolution, contrast, and response time, the current trend is toward the active matrix type, i.e., where respective unit pixels may be selectively turned on or off.

The display device may be used in a mobile information device, e.g., a personal computer, a portable phone, a PDA, and/or in a stationary system, e.g., a monitor for various kinds of information systems. The display device may be an emissive display, e.g., a liquid crystal display (LCD), an organic light emitting diode (OLED) display, a plasma display panel (PDP), etc., and weight/volume thereof may be lighter than those of a cathode ray tube (CRT) display. For example, the OLED display may exhibit excellent emissive efficiency, luminance, and viewing angle, and has a short response time.

However, when images with many red or blue color components are displayed on a conventional display device, such color components may become prominent and may not be harmonious with other color components. Furthermore, if portions in a display region are differentiated in contrast from neighboring portions thereof, contrast of an entire image displayed in the display region may be reduced. In addition, as color regions may vary among different display panels with respect to characteristics of the display panels, i.e., a same image may be expressed in different colors by different display panels, image characteristics may be deteriorated in the conventional display device.

The above information disclosed in this Background section is only for enhancement of understanding of the background of the described technology and therefore it may contain information that does not form the prior art that is already known in this country to a person of ordinary skill in the art.

### SUMMARY

Embodiments are therefore directed to a display device and a driving method thereof, which substantially overcome one or more of the problems due to the limitations and disadvantages of the related art.

It is therefore a feature of an embodiment to provide a display device structure capable of selectively improving characteristics of an image displayed thereon.

It is therefore another feature of an embodiment to provide a method of driving a display device by applying image processing signals to specific regions of a display unit to prevent image distortion.

At least one of the above and other features and advantages may be realized by providing a display device, including an image processing unit adapted to apply image processing algorithms to an input video signal to generate a corrected input video signal, the image processing unit including an input for a regional information signal, the regional information signal including coordinates representing location and boundary of at least one active region per frame in a display unit and resolution of the at least one active region, and the display unit, the display unit including the at least one active region and being adapted to display images in accordance with the corrected input video signal output by the image processing unit.

The active regions may be formed at the display unit in the shape of a quadrangle, and the regional information signals may contain information regarding the coordinates of two points on a diagonal of the quadrangle and the number of pixels contained in the quadrangle. One or more of the active regions may be provided, the regional information signal including coordinates and resolution of each active region of the plurality of active regions. Each active region of the plurality of active regions may be connected to the image processing unit independently of other active regions of the plurality of active regions, the image processing unit being adapted to independently adjust input video signals corresponding to different active regions via respective regional information signals. The at least one active region may be only a predetermined portion of a display panel of the display unit, the image processing unit being adapted to apply image processing algorithms only to the predetermined portion of the display unit. The active regions may be allocated to the display unit fixedly or movably.

The image processing algorithms may include a color harmony algorithm for analyzing color data of the input video signals so as to extract a representative color, and altering the luminosity of the representative color. The image processing algorithms may include an intelligent contrast enhancement algorithm for partitioning the display unit into a plurality of blocks, computing and storing an average luminance value of the relevant blocks by using the input video signals corresponding to the respective partitioned blocks, computing a proximity luminance value of the respective blocks by way of interpolation, comparing the computed proximity luminance and the average luminance with each other, and controlling the input video signals such that a difference between the two luminance values does not exceed a predetermined threshold value. The image processing algorithms may include a standard color reproduction algorithm for applying a matrix for converting the source color regions that are determined depending upon the characteristics of a display panel of the display unit into target color regions to the input video signals so as to correct the input signals. The image processing algorithms may include an auto current limit algorithm for computing the average luminance of the input video signals, and determines the maximum luminance value on the basis of the computed average luminance so as to output input video signals that are adapted to the maximum luminance value.

At least one of the above and other features and advantages may also be realized by providing a method of driving a display device, including generating regional information signals containing information regarding coordinates of active regions of a display unit representing locations and boundaries thereof and resolution of the active regions. Image processing algorithms may then be applied to input video signals corresponding to the active regions by using the regional information signals so as to output corrected input video signals, and images are displayed in accordance with the corrected input video signals.

The active regions may be formed at the display unit in the shape of a quadrangle, and the regional information signals may contain information regarding the coordinates of two points on a diagonal of the quadrangle and the number of pixels contained in the quadrangle. Applying image processing algorithms by the image processing unit may include selectively processing portions of an image to be displayed by the display unit by applying the image processing algorithms only to an input video signal corresponding to the at least one active region. Applying image processing algorithms by the image processing unit may include applying the image processing algorithms to at least one mobile active region, such that the regional information signal transmits coordinates and resolution of the mobile active region to the image processing unit in real time. Applying image processing algorithms by the image processing unit may include independently applying image processing algorithms to an input video signal corresponding to each active region of a plurality of active regions based on information in a respective regional information signal.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of a display device according to an exemplary embodiment;

FIG. 2 illustrates an equivalent circuit diagram of a pixel PX illustrated in FIG. 1; and

FIG. 3A and FIG. 3B illustrate active regions and corresponding location coordinates for a regional information signal according to an exemplary embodiment.

### DETAILED DESCRIPTION

Korean Patent Application No. 10-2009-0050025, filed on Jun. 5, 2009, in the Korean Intellectual Property Office, and entitled: “Display Device and Driving Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of elements and regions may be exaggerated for clarity of illustration. It will also be understood that when an element is referred to as being “on” another element or substrate, it can be directly on the other element or substrate, or intervening elements may also be present. Further, it will also be understood that when an element is referred to as being “between” two elements, it can be the only element between the two elements, or one or more intervening elements may also be present. In addition, it will also be understood that when an element is referred to as being “connected” to another element, the element may be directly connected to the other element or, e.g., electrically, connected to the other element through a third element. Also, unless explicitly described to the contrary, the word “comprise” and variations such as “comprises” or “comprising” will be understood to imply the inclusion of stated elements but not the exclusion of any other elements. Like reference numerals refer to like elements throughout.

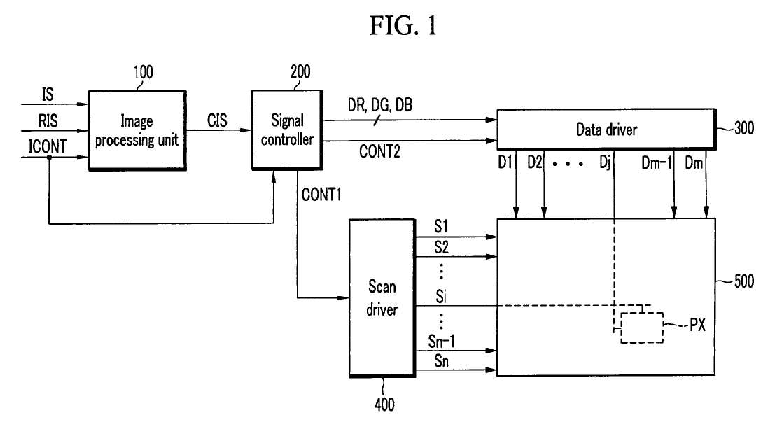

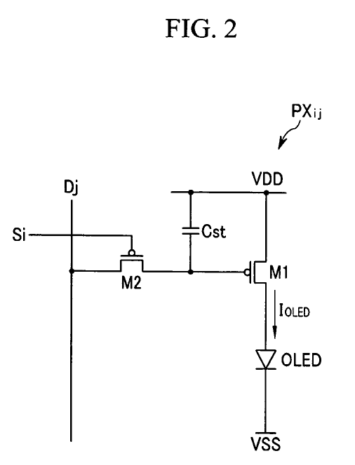

FIG. 1 illustrates a block diagram of a display device, e.g., an OLED display device, according to an exemplary embodiment. FIG. 2 illustrates an equivalent circuit diagram of a pixel PX shown in FIG. 1.

Referring to FIG. 1, a display device according to an exemplary embodiment may include an image processing unit 100, a signal controller 200, a data driver 300, a scan driver 400, and a display unit 500. The image processing unit 100 may process an input video signal IS corresponding to a specific region of the display unit 500 based on regional information of the specific region in order to output a corrected image input signal CIS for the specific region of the display unit 500, thereby preventing or substantially minimizing display of distorted images via the display unit 500. In other words, as the image processing unit 100 outputs a corrected image input signal CIS to a specific region of the display unit 500, the image processing unit 100 may process an image displayed by the display unit 500 selectively, e.g., only a portion of an entire image may be image-processed based on its specific characteristics.

In particular, as illustrated in FIG. 1, the input video signals IS, control signals ICONT, and regional information signals RIS may be input into the image processing unit 100. The image processing unit 100 may apply image processing algorithms to the input video signals IS corresponding to regions to be image-processed (referred to hereinafter as the active regions) per frame by using the control signals ICONT and regional information signals RIS, so as to output the corrected image input signals CIS.

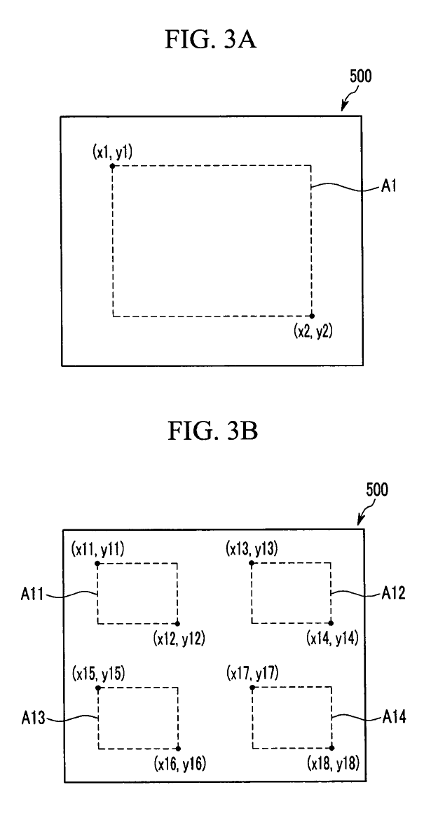

The control signals ICONT may include horizontal synchronization signals Hsync and vertical synchronization signals Vsync. The regional information signals RIS may include information regarding coordinates of the active regions (see, e.g., A1 in FIG. 3A), e.g., locations and boundaries of each specific region within the display unit 500 (see, e.g., x and y coordinates in FIG. 3A), and the resolution of the active regions. The regional information signals RIS and the active regions will be described in more detail below with reference to FIG. 3A and FIG. 3B.

The image processing algorithms applied by the image processing unit 100 according to an exemplary embodiment may include, e.g., a color harmony (CH) algorithm, an intelligent contrast enhancement (ICE) algorithm, a standard color reproduction (SCR) algorithm, and an auto current limit (ACL) algorithm. The respective algorithms will now be specifically described.

The CH algorithm may analyze a color data of the input video signals IS to determine, i.e., extract, the most extensively distributed color component therein as a representative color, and may alter luminosity of the representative color accordingly. For example, if the CH algorithm determines that the representative color in the input video signals IS is red, i.e., the most extensively distributed color component in the image signal, the luminosity of the red color may be lowered. In another example, if the CH algorithm determines that the representative color in the input video signals IS is blue, the luminosity of the blue color may be heightened to improve harmony of the blue color with other colors neighboring thereto.

The ICE algorithm may partition the display unit 500 into a plurality of blocks, and may compute and store an average luminance value of the blocks, e.g., of each relevant block, by using input video signals IS corresponding to respective partitioned blocks. A proximity luminance value of the respective blocks may be computed by way of interpolation. The computed proximity luminance and the average luminance may be compared with each other, and the input video signals IS may be controlled, such that the difference between the two luminance values may not exceed a predetermined threshold value.

The SCR algorithm may convert source color regions in the display unit 500, i.e., as determined by characteristics of a display panel of the display unit 500, into target color regions. For example, the source color regions may be differentiated from each other, e.g., by color intensity, in different display panels, so different display panels may display different colors for an image on the display unit 500 generated by a same input video signal. In order to correct such color difference among display panels, the SCR algorithm may apply a matrix that converts the source color regions of each display panel into target color regions to input video signals. That is, the SCR algorithm may correct image data, such that the images displayed in accordance with the input video signals IS may have the target color regions, e.g., have increased color uniformity among display panels.

The ACL algorithm may compute the average luminance of the input video signals IS. The ACL algorithm may determine a maximum luminance value on the basis of the computed average luminance, so the corrected input video signal CIS may be adapted to the maximum luminance value.

With the image processing algorithms according to an exemplary embodiment, the CH algorithm, the ICE algorithm, the SCR algorithm, and the ACL algorithm may be sequentially applied for use. However, an exemplary embodiment is not limited thereto, and the application sequence may be altered.

Referring back to FIG. 1, the signal controller 200 may receive the corrected input video signals CIS and the control signals ICONT from the image processing unit 100, and may generate image data signals DR, DG, and DB, scan control signals CONT1, and data control signals CONT2. The scan control signals CONT1 may include a scan start signal STV, and at least one clock signal for controlling the output cycle of the gate-on voltage Von. The scan control signals CONT1 may further include an output enable signal OE for defining the duration of the gate-on voltage Von. The data control signals CONT2 may include horizontal synchronization start signals STH for starting the transmission of the image data signals DR, DG, and DB with respect to a row of pixels PX to the data driver 300, and load signals LOAD for applying data voltages to the data lines D1 to Dm.

The data driver 300 may be connected to the data lines D1 to Dm of the display unit 500. The data driver 300 may convert the data signals DR, DG, and DB input from the signal controller 200 into data voltages in accordance with the data control signals CONT2 so as to apply them to the data lines D1 to Dm.

The scan driver 400 may be connected to the scan lines S1 to Sn of the display unit 500, and may sequentially apply scan signals to the scan lines S1 to Sn in accordance with the scan control signals CONT1. The scan signals may include a gate-on voltage Von for turning on a switching transistor M2, and a gate-off voltage Voff for turning off the switching transistor M2. In case the switching transistor M2 is a p-channel field effect transistor (FET), the gate-on voltage Von and the gate-off voltage Voff are low and high voltages, respectively.

From the viewpoint of an equivalent circuit, the display unit 500 may include a plurality of signal lines S1 to Sn and D1 to Dm, and a plurality of pixels PX connected to the signal lines and arranged, e.g., in a form of a matrix. The signal lines 51 to Sn and D1 to Dm may include a plurality of scan lines S1 to Sn for transmitting scan signals to the pixels PX, and a plurality of data lines D1 to Dm for transmitting data voltages to the pixels PX. The scan lines S1 to Sn may extend roughly in a pixel row direction and may be substantially parallel to each other. The data lines D1 to Dm may extend roughly in a pixel column direction, e.g., perpendicularly to the pixel row direction, and may be substantially parallel to each other.

Referring to FIG. 2, each pixel PX, e.g., pixel PXij connected to the i-th (i=1, 2, . . . , n) scan line Si and the j-th (j=1, 2, . . . , m) data line Dj, may include a driving transistor M1, a capacitor Cst, the switching transistor M2, and an organic light emitting element, e.g., an organic light emitting diode (OLED). The pixel PX may further include an emission control transistor (not illustrated).

The driving transistor M1 has a control terminal, an input terminal, and an output terminal. The control terminal of the driving transistor M1 may be connected to the switching transistor M2, while the input terminal thereof may be connected to a driving voltage VDD and the output terminal thereof may be connected to the OLED. The driving transistor M1 may outflow an electric current L_{OLED} that is varied in dimension depending upon the voltages held between the control and output terminals of the driving transistor M1.

The switching transistor M2 has a control terminal, an input terminal, and an output terminal. The control terminal of the switching transistor M2 may be connected to the scan line Si, while the input terminal thereof may be connected to the data line Dj and the output terminal thereof may be connected to the driving transistor M1. The switching transistor M2 may transmit a data signal, e.g., a data voltage, from the data line Dj to the control of the driving transistor M1 in response to the scan signal applied to the scan line Si.

The capacitor Cst may be connected between the control and input terminals of the driving transistor M1. The capacitor Cst charges the data voltage applied to the control terminal of the driving transistor M1, and stores it even after the switching transistor M2 is turned off.

The organic light emitting element may be an OLED, and may have an anode connected to the output terminal of the driving transistor M1 and a cathode connected to a common voltage VSS. The organic light emitting element may emit light that is varied in intensity depending upon the electric current I_{OLED} supplied from the driving transistor M1 so as to display an image.

The organic light emitting element may emit light of one of primary colors. The primary colors may be three primary colors of red, green, and blue, and the desired color may be expressed by a spatial or temporal sum of the three primary colors. Some of the organic light emitting elements may emit light of a white color so as to heighten the luminance. Alternatively, the organic light emitting elements at all of the pixels PX may emit light of a white color, and in this case, some of the pixels PX may further include a color filter (not shown) for converting the white-colored light from the organic light emitting element into any one of the primary colors.

The driving transistor M1 and the switching transistor M2 may each be a p-channel FET. In this case, the control terminal, the input terminal, and the output terminal correspond to a gate, a source, and a drain, respectively. However, at least one of the switching transistor M2 and the driving transistor M1 may be an re-channel FET. Furthermore, the transistors M1 and M2, the capacitor Cst, and the organic light emitting element may be changed in interconnection. For example, the structure of pixel PXij shown in FIG. 2 may be changed to include a different structure with at least two transistors or at least one capacitor.

FIG. 3A and FIG. 3B illustrate regional information signals RIS and active regions within the display unit 500 according to an exemplary embodiment.

The active regions within the display unit 500 may be defined or predetermined in any suitable geometrical shape, e.g., in a quadrangular shape, and the locations and borderlines of the active regions may be indicated by coordinates of a line within the geometrical shape, e.g., coordinates of two points on the diagonal of the quadrangle. For example, if the active region is a quadrangle, the regional information signal RIS may include coordinates of a top point on the diagonal, i.e., a start point, and coordinates of a bottom point of the diagonal, i.e., an end point.

For example, referring to FIG. 3A, the active region A1 of the display unit 500 may be defined by the coordinates of the start point (x1, y1), and the coordinates of the end point (x2, y2). Resolution of the active region A1 may be determined by a number of pixels PX positioned in the active region A1, i.e., may be known from the coordinates of the start point (x1, y1) and the coordinates of the end point (x2, y2). Accordingly, the regional information signal RIS may include information regarding the coordinates of the start and end points (x1, y1) and (x2, y2) of the active region A1, and the number of pixels PX thereof.

The display unit may include one active region A1, as illustrated in FIG. 3A, or a plurality of active regions, as illustrated in FIG. 3B. For example, as illustrated in FIG. 3B, the display unit 500 may include a plurality of active regions A11 to A14, so the regional information signals RIS may include information regarding the coordinates of the start and end points of each of the respective active regions A11 to A14. That is, the regional information signals RIS may include information regarding the coordinates of the start and end points (x11, y1) and (x12, y12) of the first active region A11, the coordinates of the start and end points (x13, y13) and (x14, y14) of the second active region A12, the coordinates of the start and end points (x15, y15) and (x16, y16) of the third active region A13, and the coordinates of the start and end points (x17, y17) and (x18, y18) of the fourth active region A14. Furthermore, the regional information signals RIS may include information regarding the resolution of the respective active regions A11 to A14 based on the number of pixels PX thereof. For example, each active region of the plurality of active regions A11 to A14 may be connected, e.g., electrically, to the image processing unit 100 independently of other active regions of the plurality of active regions, so the image processing unit 100 may independently adjust an input video signal SI of a respective active regions via its corresponding regional information signal RIS. In other words, for example, the image processing unit 100 may apply one or more of the CH algorithm, the ICE algorithm, the SCR algorithm, and the ACL algorithm to only one of the regions A11 to A14 to correct its color and/or display properties.

The active regions may be stationary in the display unit 500, e.g., the display device may have a single active region A1 with fixed coordinates of the start and end points as illustrated in FIG. 3A. Alternatively or additionally, the active regions may be mobile within the display unit 500, e.g., the display device may have an option of replacing the active region A1 corresponding to a majority of a display panel with smaller active regions A11 to A14 displaying different images on the display panel illustrated in FIG. 3B, so the regional information signals RIS may transmit the variable coordinates and the resolution of the corresponding mobile active regions to the image processing unit 100 in real time. For example, when the regions except for the menu region for the user interface are allocated to the display unit 500 as the active regions according to an exemplary embodiment, images displayed at the active regions is prevented from being distorted due to the image contained in the menu region during the application of the image processing algorithms.

It is noted that while according to exemplary embodiments image processing algorithms are applied to active regions, embodiment are not limited thereto. For example, the image processing algorithms may be applied to regions other than the active regions of the display unit 500.

A display device having a structure according to an exemplary embodiment may include an image processing unit that applies image processing algorithms to only predetermined regions of a display unit 500 based on information specific, i.e., customized, to the predetermined regions. Since image processing may be customized and performed on some regions of the display unit 500 and not on an entire display unit 500, display properties of the display device, e.g., image processing effect, may be substantially improved.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display device, comprising:
an image processing unit adapted to apply image processing algorithms to an input video signal to generate a corrected input video signal, the image processing unit including an input for a regional information signal, the regional information signal including coordinates representing location and boundary of at least one active region per frame in a display unit and resolution of the at least one active region; and
the display unit, the display unit including the at least one active region and being adapted to display images in accordance with the corrected input video signal output by the image processing unit.

2. The display device as claimed in claim 1, wherein the active regions in the display unit have a quadrangular shape, and the regional information signal includes coordinates of two points on a diagonal of the quadrangular shape and a number of pixels in the quadrangular shape.

3. The display device as claimed in claim 1, wherein the display unit includes a plurality of active regions, the regional information signal including coordinates and resolution of each active region of the plurality of active regions.

4. The display device as claimed in claim 3, wherein each active region of the plurality of active regions is connected to the image processing unit independently of other active regions of the plurality of active regions, the image processing unit being adapted to independently adjust input video signals corresponding to different active regions via respective regional information signals.

5. The display device as claimed in claim 1, wherein the at least one active region is only a predetermined portion of a display panel of the display unit, the image processing unit being adapted to apply image processing algorithms only to the predetermined portion of the display unit.

6. The display device as claimed in claim 1, wherein the at least one active region in the display unit is stationary, coordinates of the stationary active region being fixed.

7. The display device as claimed in claim 1, wherein the at least one active region in the display unit is mobile, coordinates of the mobile active region being variable.

8. The display device as claimed in claim 1, wherein the image processing algorithms of the image processing unit include a color harmony algorithm, the color harmony algorithm being adapted to extract a representative color from color data in the input video signal and to alter luminosity of the representative color.

9. The display device as claimed in claim 1, wherein the image processing algorithms of the image processing unit include an intelligent contrast enhancement algorithm, the intelligent contrast enhancement algorithm being adapted to control the input video signal to maintain a difference between an average luminance and a proximity luminance in a plurality of portions of the display unit below a predetermined threshold value.

10. The display device as claimed in claim 1, wherein the image processing algorithms of the image processing unit include a standard color reproduction algorithm, the standard color reproduction algorithm being adapted to adjust the input video signal via application of a matrix to have uniform color regions regardless of display panel characteristics.

11. The display device as claimed in claim 1, wherein the image processing algorithms of the image processing unit include an auto current limit algorithm, the auto current limit algorithm being adapted to output the corrected input video signal in accordance with a maximum luminance value, the maximum luminance value being determined in accordance with a computed average luminance of the input video signal.

12. A method of driving a display device including an image processing unit and a display unit, the method comprising:
generating a regional information signal including coordinates representing location and boundary of at least one active region per frame in the display unit and resolution of the at least one active region;
applying image processing algorithms by the image processing unit to an input video signal to generate a corrected input video signal, the input video signal corresponding to the at least one active region by using the generated regional information signal; and
displaying images in accordance with the corrected input video signal via the display unit.

13. The method as claimed in claim 12, wherein generating the regional information signal includes generating information regarding at least one quadrangular active region, such that the regional information signal includes coordinates of two points on a diagonal of the quadrangular active region and a number of pixels in the quadrangular active region.

14. The method as claimed in claim 12, wherein applying image processing algorithms by the image processing unit includes selectively processing portions of an image to be displayed by the display unit by applying the image processing algorithms only to an input video signal corresponding to the at least one active region.

15. The method as claimed in claim 12, wherein applying image processing algorithms by the image processing unit includes applying the image processing algorithms to at least one mobile active region, such that the regional information signal transmits coordinates and resolution of the mobile active region to the image processing unit in real time.

16. The method as claimed in claim 12, wherein applying image processing algorithms by the image processing unit includes independently applying image processing algorithms to an input video signal corresponding to each active region of a plurality of active regions based on information in a respective regional information signal.

17. The method as claimed in claim 12, wherein applying image processing algorithms includes applying a color harmony algorithm for analyzing color data of the input video signal so as to extract a representative color, and altering luminosity of the representative color.

18. The method as claimed in claim 12, wherein applying image processing algorithms includes applying an intelligent contrast enhancement algorithm for partitioning the display unit into a plurality of blocks, computing and storing an average luminance value of the blocks by using input video signals corresponding to respective blocks, computing a proximity luminance value of the respective blocks by way of interpolation, comparing the computed proximity luminance and the average luminance with each other, and controlling the input video signals, such that a difference between the two luminance values does not exceed a predetermined threshold value.

19. The method as claimed in claim 12, wherein applying image processing algorithms includes applying a standard color reproduction algorithm for converting source color regions via matrix application into target color regions in the corrected input video signal, the source color regions being determined by characteristics of a display panel of the display unit.

20. The method as claimed in claim 12, wherein applying image processing algorithms includes applying an auto current limit algorithm for computing an average luminance of the input video signal, determining a maximum luminance value on the basis of the computed average luminance, and adapting the output corrected input video signal to the maximum luminance value.
